(19) United States
(12) Patent Application Publication
(10) Pub. No.: US 2012/0006259 A1
(43) Pub. Date: Jan. 12, 2012

(54) TENSION APPARATUS FOR PATTERNING SLIT SHEET

(75) Inventors: Un-Cheol SUNG, Yongin-City (KR); Mu-Hyun KIM, Yongin-City (KR); Dong-Seob JEONG, Yongin-City (KR); Jung-Yeon KIM, Yongin-City (KR)

(73) Assignee: Samsung Mobile Display Co., Ltd., Yongin-City (KR)

(21) Appl. No.: 12/984,231

(22) Filed: Jan. 4, 2011

(30) Foreign Application Priority Data
Jul. 12, 2010 (KR) 10-2010-0066992

(51) Int. Cl. B05C 11/00; G02B 26/02

(52) U.S. Cl. 118/213; 359/232; 118/620

(57) ABSTRACT

A tension apparatus for extending a patterning slit sheet included in a thin film deposition apparatus that can be simply applied to produce large-sized display devices on a mass scale and that improves manufacturing yield. The tension apparatus, wherein a plurality of patterning slits are formed along a first direction in the patterning slit sheet, and distances between adjacent patterning slits are different from each other, includes: a light source disposed to face the patterning slit sheet and irradiating light toward the patterning slit sheet; a tension member combined to at least one end of the patterning slit sheet, and applying a predetermined tensile force on the patterning slit sheet; and a master glass onto which light irradiated from the light source and passed through the patterning slit sheet is projected.

### CROSS-REFERENCE TO RELATED APPLICATION

This application claims the benefit of Korean Application No. 10-2010-0066992, filed Jul. 12, 2010 in the Korean Intellectual Property Office, the disclosure of which is incorporated herein by reference.

### BACKGROUND

1. Field

One or more aspects of the present invention relate to a tension apparatus for a patterning slit sheet, and more particularly, to a tension apparatus for extending a patterning slit sheet included in a thin film deposition apparatus that can be simply applied to produce large-sized display devices on a mass scale and that improves manufacturing yield.

2. Description of the Related Art

Organic light-emitting display devices have a larger viewing angle, better contrast characteristics, and a faster response rate than other display devices, and thus have drawn attention as next-generation display devices.

Organic light-emitting display devices generally have a stacked structure including an anode, a cathode, and an emission layer interposed between the anode and the cathode. The devices display images in color when holes and electrons, injected respectively from the anode and the cathode, recombine in the emission layer, and thus light is emitted. However, it is difficult to achieve high light-emission efficiency with such a structure, and thus intermediate layers, including an electron injection layer, an electron transport layer, a hole transport layer, a hole injection layer, etc., are optionally additionally interposed between the emission layer and each of the electrodes.

However, it is practically very difficult to form fine patterns in organic thin films such as the emission layer and the intermediate layers, and red, green, and blue light-emission efficiency varies according to variations in the organic thin films. For these reasons, it is not easy to form an organic thin film pattern on a large substrate, such as a mother glass having a size of 5G or more, by using a conventional thin film deposition apparatus, and thus it is difficult to manufacture large organic light-emitting display devices having satisfactory driving voltage, current density, brightness, color purity, light-emission efficiency, and life-span characteristics. Thus, there is a demand for improvement in this regard.

An organic light-emitting display device includes intermediate layers, including an emission layer disposed between a first electrode and a second electrode that are arranged opposite to each other. The electrodes and the intermediate layers may be formed via various methods, one of which is a deposition method. When an organic light-emitting display device is manufactured using the deposition method, a fine metal mask (FMM) having the same pattern as a thin layer to be formed is disposed to closely contact a substrate, and a thin film material is deposited over the FMM in order to form the thin layer having the desired pattern.

### SUMMARY

One or more aspects of the present invention provide a tension apparatus for a patterning slit sheet, and more particularly, a tension apparatus for extending a patterning slit sheet included in a thin film deposition apparatus that can be simply applied to produce large-sized display devices on a mass scale and that improves manufacturing yield.

An aspect of the present invention provides a tension apparatus for extending a patterning slit sheet, wherein a plurality of patterning slits are formed along a first direction in the patterning slit sheet, and distances between adjacent patterning slits are different from each other, the tension apparatus including: a light source disposed to face the patterning slit sheet and irradiating light toward the patterning slit sheet; a tension member combined with at least one end of the patterning slit sheet, and applying a predetermined tensile force on the patterning slit sheet; and a master glass onto which light irradiated from the light source and passed through the patterning slit sheet is projected.

A predetermined reference pattern may be formed on the master glass.

The reference pattern may be a stripe type pattern of equal intervals.

The reference pattern may have the same shape as a thin film pattern deposited on a substrate by the patterning slit sheet.

The tension apparatus may further include a photographing apparatus for photographing a pattern of the light projected onto the master glass after being irradiated from the light source and passed through the patterning slit sheet, and the reference pattern formed on the master glass.

The tension member may extend the patterning slit sheet in such a way that the pattern of the light and the reference pattern photographed by the photographing apparatus are identical.

The tension apparatus may further include a gap sensor for measuring an interval between the patterning slit sheet and the master glass, and a gap control member for uniformly maintaining the measured interval between the patterning slit sheet and the master glass.

The light source may be formed at a location corresponding to a deposition source of a thin film deposition apparatus including the patterning slit sheet.

The distances between the patterning slits may decrease the farther they are from the center of the patterning slit sheet along the first direction.

The patterning slits may be biased toward the center of the patterning slit sheet compared to when the patterning slits are disposed on the patterning slit sheet at equal intervals.

The patterning slits may be more biased toward the center of the patterning slit sheet the farther they are from the center of the patterning slit sheet.

According aspect of the present invention provides a patterning slit sheet manufactured by using the tension apparatus.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings, of which:

FIG. 1 is a schematic perspective view of a thin film deposition apparatus including a patterning slit sheet, according to an embodiment of the present invention;

FIG. 2 is a schematic side view of the thin film deposition apparatus of FIG. 1 in the Y-Z plane;

FIG. 3 is a schematic plan view of the thin film deposition apparatus of FIG. 1 in the X-Z plane;

FIG. 4A illustrates patterning slits arranged in a patterning slit sheet at equal intervals in the thin film deposition apparatus of FIG. 1;

FIG. 4B illustrates a thin film formed on a substrate by using the patterning slit sheet of FIG. 4A;

FIG. 4C is a graph of a pattern shift according to the distance from the center of the patterning slit sheet to each patterning slit;

FIG. 5A illustrates neighboring patterning slits formed nearer together the farther they are from the center of a patterning slit sheet, in the thin film deposition apparatus of FIG. 1, according to another embodiment of the present invention;

FIG. 5B illustrates a thin film formed on a substrate by using the patterning slit sheet of FIG. 5A;

FIG. 6 is an exploded view illustrating the combined structure of a patterning slit sheet and a frame, according to another embodiment of the present invention; and

FIG. 7 is a schematic view of a tension apparatus for a patterning slit sheet, according to the embodiment of FIG. 6.

### DETAILED DESCRIPTION

Reference will now be made in detail to the present embodiments of the present invention, examples of which are illustrated in the accompanying drawings, wherein like reference numerals refer to the like elements throughout. The embodiments are described below in order to explain the present invention by referring to the figures.

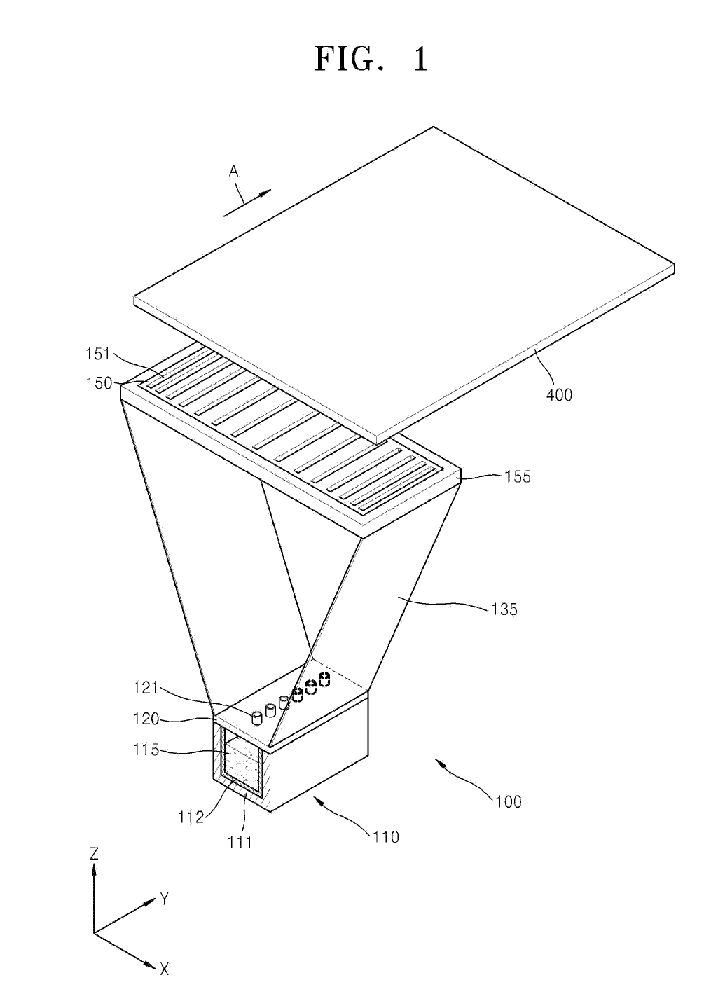

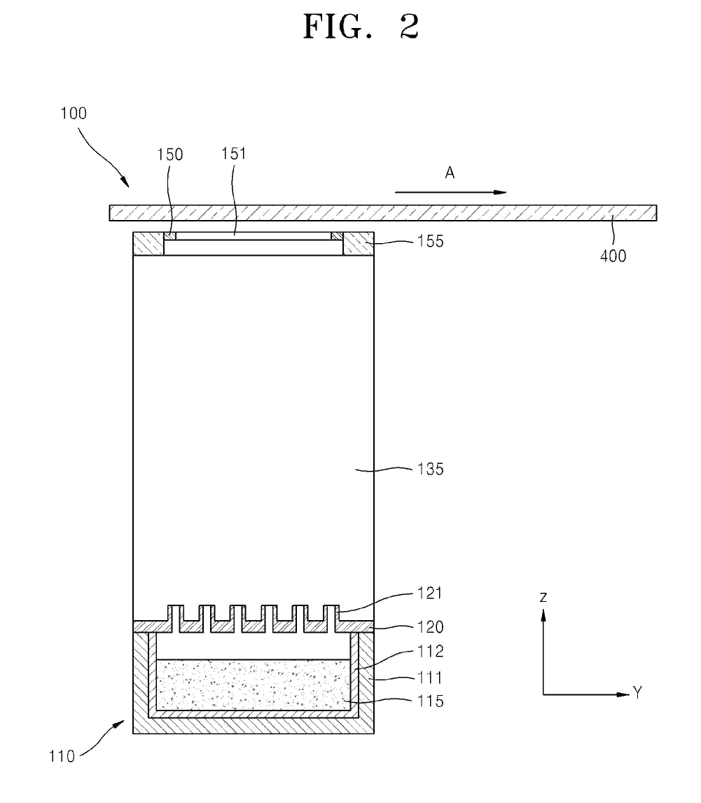

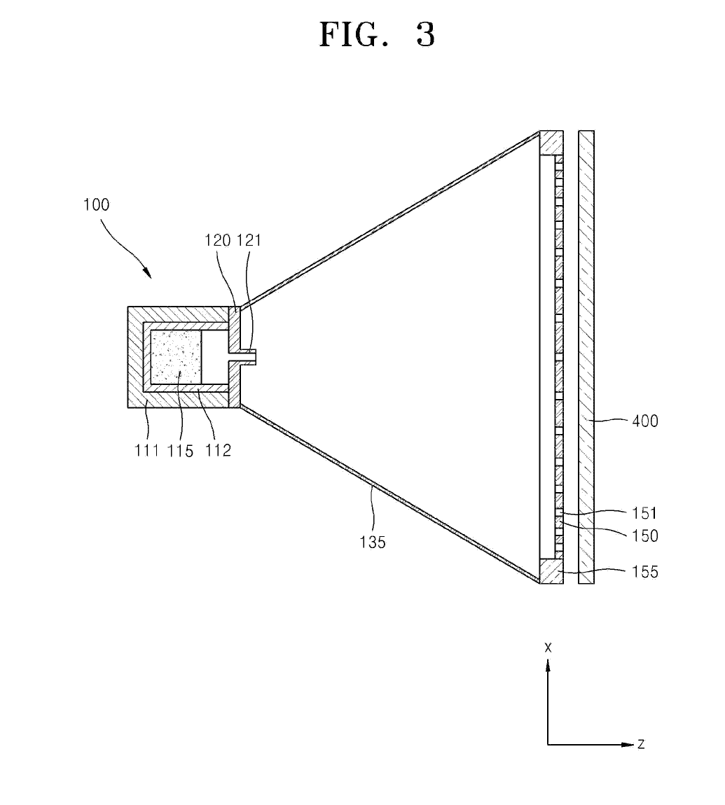

FIG. 1 is a schematic perspective view of a thin film deposition apparatus 100 including a patterning slit sheet 150 according to an embodiment of the present invention, FIG. 2 is a schematic side view of the thin film deposition apparatus 100 of FIG. 1 in the Y-Z plane, and FIG. 3 is a schematic plan view of the thin film deposition apparatus 100 of FIG. 1 in the X-Z plane. Referring to FIGS. 1, 2 and 3, the thin film deposition apparatus 100 according to the current embodiment of the present invention includes a deposition source 110, a deposition source nozzle unit 120, and a patterning slit sheet 150.

Although a chamber is not illustrated in FIGS. 1, 2 and 3 for convenience of explanation, all the components of the thin film deposition apparatus 100 may be disposed within a chamber that is maintained at an appropriate degree of vacuum. The chamber is maintained at an appropriate degree of vacuum in order to allow a deposition material to move in a substantially straight line through the thin film deposition apparatus 100.

In particular, in order to deposit a deposition material 115 that is emitted from the deposition source 110 and is discharged through the deposition source nozzle unit 120 and the patterning slit sheet 150 onto a substrate 400 in a desired pattern, the chamber must be maintained in a high-vacuum state as in a deposition method using a fine metal mask (FMM). In addition, the temperature of the patterning slit sheet 150 has to be sufficiently lower than the temperature of the deposition source 110. In this regard, the temperature of the patterning slit sheet 150 may be about 100° C. or less. The temperature of the patterning slit sheet 150 should be sufficiently low so as to reduce thermal expansion of the patterning slit sheet 150.

The substrate 400 that is a deposition target substrate is disposed in the chamber. The substrate 400 may be a substrate for flat panel displays. A large substrate, such as a mother glass, for manufacturing a plurality of flat panel displays may be used as the substrate 400. Other substrates may also be employed.

In the current embodiment of the present invention, deposition may be performed while the substrate 400 or the thin film deposition apparatus 100 is moved relative to the other. In particular, in the conventional FMM deposition method, the size of the FMM has to be equal to the size of a substrate. Thus, the size of the FMM has to be increased as the substrate becomes larger. However, it is neither straightforward to manufacture a large FMM nor to extend the size of an FMM and have the FMM accurately aligned with a pattern.

In order to overcome these problems, in the thin film deposition apparatus 100 according to the current embodiment, deposition may be performed while the thin film deposition apparatus 100 or the substrate 400 is moved relative to the other. In other words, deposition may be continuously performed while the substrate 400, which is disposed so as to face the thin film deposition apparatus 100, is moved in the Y-axis direction. In other words, deposition is performed in a scanning manner while the substrate 400 is moved in a direction indicated by arrow A in FIG. 1. Although the substrate 400 is illustrated as being moved in the Y-axis direction in FIGS. 1 and 2 when deposition is performed, aspects of the present invention are not limited thereto. For example, deposition may be performed while the thin film deposition apparatus 100 is moved in the Y-axis direction, whereas the substrate 400 is fixed.

Thus, in the thin film deposition apparatus 100 according to the current embodiment, the patterning slit sheet 150 may be significantly smaller than an FMM used in a conventional deposition method. In other words, in the thin film deposition apparatus 100 according to the current embodiment, deposition is continuously performed, i.e., in a scanning manner while the substrate 400 is moved in the Y-axis direction. Thus, lengths of the patterning slit sheet 150 in the X-axis and Y-axis directions may be significantly less than the lengths of the substrate 400 in the X-axis and Y-axis directions. As described above, since the patterning slit sheet 150 may be formed to be significantly smaller than an FMM used in a conventional deposition method, it is relatively easy to manufacture the patterning slit sheet 150 used in these aspects of the present invention. In other words, using the patterning slit sheet 150, which is smaller than an FMM used in a conventional deposition method, is more convenient for all processes, including etching and other subsequent processes such as precise extension, welding, moving, and cleaning processes, compared to the conventional deposition method using the larger FMM. This is particularly advantageous for a relatively large display device.

In order to perform deposition while the thin film deposition apparatus 100 or the substrate 400 is moved relative to the other as described above, the thin film deposition apparatus 100 and the substrate 400 may be separated from each other by a predetermined distance. This will be described later in detail.

The deposition source 110 that contains and heats the deposition material 115 is disposed in an opposite side of the chamber from the side in which the substrate 400 is disposed. When the deposition material 115 contained in the deposition source 110 is vaporized, the deposition material 115 is deposited on the substrate 400.

In particular, the deposition source 110 includes a crucible 111 that is filled with the deposition material 115, and a heater 112 that heats the crucible 111 to vaporize the deposition material 115, which is contained in the crucible 111, towards a side of the crucible 111, and in particular, toward the deposition source nozzle unit 120. The deposition source nozzle unit 120 is disposed at a side of the deposition source 110, and in particular, at the side of the deposition source 110 facing the substrate 400. The deposition source nozzle unit 120 includes a plurality of deposition source nozzles 121 that may be arranged at equal intervals in the Y-axis direction. The deposition material 115 that is vaporized in the deposition source 110 passes through the deposition source nozzle unit 120 toward the substrate 400.

The patterning slit sheet 150 and a frame 155 in which the patterning slit sheet 150 is bound are disposed between the deposition source 110 and the substrate 400. The frame 155 may be formed in a lattice shape, similar to a window frame. The patterning slit sheet 150 is bound inside the frame 155. The patterning slit sheet 150 includes a plurality of patterning slits 151 arranged in the X-axis direction. The deposition material 115 that is vaporized in the deposition source 110 passes through the deposition source nozzle unit 120 and the patterning slit sheet 150 toward the substrate 400. The patterning slit sheet 150 may be manufactured by etching, which is the same method as used in the conventional method of manufacturing an FMM, and in particular, a striped FMM.

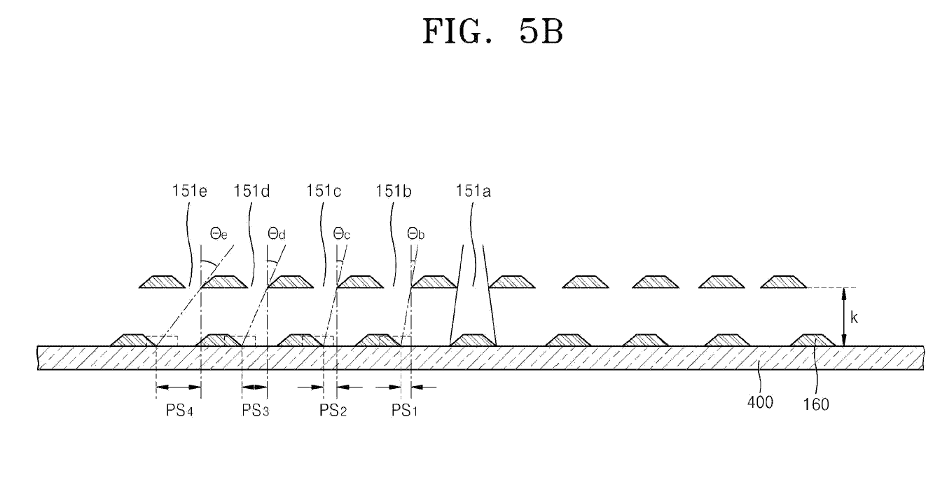

Here, in the thin film deposition apparatus 100 according to the current embodiment, the patterning slit sheet 150 is formed in such a way that intervals between the patterning slits 151 of the patterning slit sheet 150 are not the same, in particular, in a way that the intervals between the neighboring patterning slits 151 increase the farther they are from the center of the patterning sit sheet 150. The structure of the patterning slit sheet 150 will be described in detail later (see FIGS. 5A and 5B).

In addition, the deposition source 110 and the deposition source nozzle unit 120 coupled to the deposition source 110 may be disposed to be separated from the patterning slit sheet 150 by a predetermined distance. Alternatively, the deposition source 110 and the deposition source nozzle unit 120 coupled to the deposition source 110 may be connected to the patterning slit sheet 150 by a connection member 135. That is, the deposition source 110, the deposition source nozzle unit 120, and the patterning slit sheet 150 may be integrally formed as one body by being connected to each other via the connection member 135. The connection member 135 guides the deposition material, which is discharged through the deposition source nozzles 121, so as not to be dispersed. In FIG. 1, the connection members 135 are formed on left and right sides of the deposition source 110, the deposition source nozzle unit 120, and the patterning slit sheet 150 to guide the deposition material not to flow in the X-axis direction; however, aspects of the present invention are not limited thereto. That is, the connection member 135 may be formed as a sealed box to guide the deposition material to not flow either in the X-axis or Y-axis directions.

As described above, the thin film deposition apparatus 100 according to the current embodiment performs deposition while being moved relative to the substrate 400. In order to move the thin film deposition apparatus 100 relative to the substrate 400, the patterning slit sheet 150 is separated from the substrate 400 by a predetermined distance.

In particular, in a conventional deposition method using an FMM, deposition is performed with the FMM in close contact with a substrate in order to prevent formation of a shadow zone on the substrate. However, when the FMM is used in close contact with the substrate, the contact may cause defects. In addition, in the conventional deposition method, the size of the mask has to be the same as the size of the substrate since the mask cannot be moved relative to the substrate. Thus, the size of the mask has to be increased as display devices become larger. However, it is not easy to manufacture such a large mask.

In order to overcome this problem, in the thin film deposition apparatus 100 according to the current embodiment, the patterning slit sheet 150 is disposed to be separated from the substrate 400 by a predetermined distance. As described above, a mask is formed to be smaller than a substrate, and deposition is performed while the mask is moved relative to the substrate. Thus, the mask can be easily manufactured. In addition, defects caused due to the contact between a substrate and an FMM, which occur in the conventional deposition method, may be prevented. Furthermore, since it is unnecessary to dispose the FMM in close contact with the substrate during a deposition process, the manufacturing time may be reduced.

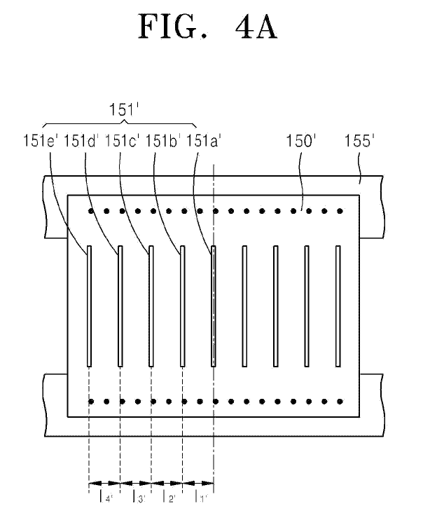

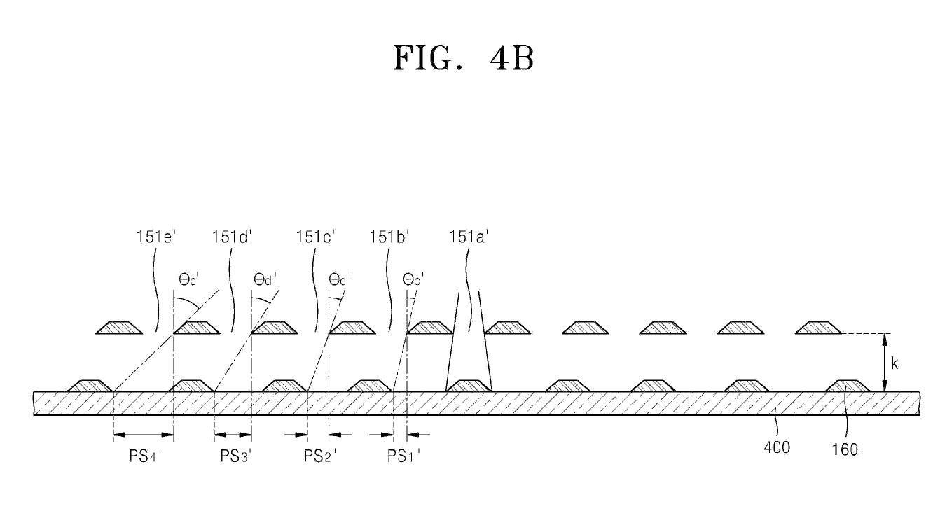

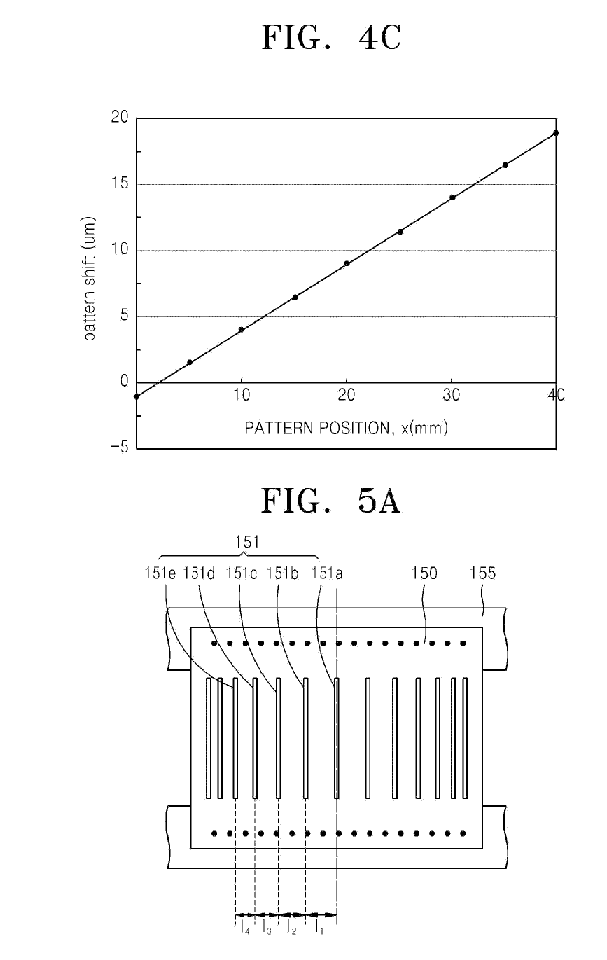

Hereinafter, a structure of the patterning slits 151 formed on the patterning slit sheet 150 of the thin film deposition apparatus 100 according to an embodiment of the present invention will be described in detail. FIG. 4A illustrates patterning slits 151′ arranged at equal intervals in a patterning slit sheet 150′ in the thin film deposition apparatus 100 of FIG. 1, and FIG. 4B illustrates a thin film 160 formed on the substrate 400 (not shown) by using the patterning slit sheet 150′ of FIG. 4A. FIG. 4C is a graph of a pattern shift according to the distance from the center of the patterning slit sheet 150′ to each patterning slit 151′.

FIGS. 4A and 4B illustrate the patterning slit sheet 150′ including the patterning slits 151′ disposed at equal intervals. That is, in FIG. 4A, the relationship I_{1′}=I_{2′}=I_{3′}=I_{4′} is established.

In this case, deposition material that passes through the patterning slit 151a′ disposed directly below the deposition source nozzle 121 of FIG. 1 has an incident angle substantially perpendicular to the substrate 400. Accordingly, a thin film 160 formed by the deposition material that passes through a patterning slit 151a′ is formed directly underneath the patterning slit 151a′, that is, at an incident angle θ of 0° from the vertical.

However, the deposition material passing through a patterning slit 151 far away from the deposition source nozzle 121 may have a greater critical incident angle θ, and thus the deposition material that passes through, for example, patterning slit 151e′ disposed at an end region of the deposition source nozzle 121 may have a critical incident angle θ of about 55°. Accordingly, the deposition material is incident on the patterning slit 151e′ while being inclined, and the thin film 160 formed by the deposition material that passes through the patterning slit 151e′ is somewhat shifted to the left from the patterning slit 151e′.

Here, a shift of the deposition material may be determined according to Equation 1 below.

Max pattern shift=k*tan θ=k*(2x−dₛ)/2h [Equation 1]

Here, k denotes the distance between a patterning slit sheet and a substrate, θ denotes a critical incident angle of a deposition material, x denotes the distance from a the center of the patterning slit sheet, dₛ denotes the width of the deposition source nozzles, and h denotes the distance between the deposition source and the patterning slit sheet 150.

In other words, the pattern shift increases as the critical incident angle θ of the deposition material increases, and the critical incident angle θ of the deposition material increases as the distance between the patterning slit 151′ to the center of the patterning slit sheet 150′ increases. The relationship between the distance from the patterning slit 151′ to the center of the patterning slit sheet 150′, and the pattern shift is shown in FIG. 4C. Here, k denotes the distance between the patterning slit sheet 150 and the substrate 400, dₛ denotes the width of each of the deposition source nozzles 121, and h denotes a distance between the deposition source 110 and the patterning slit sheet 150, wherein the distance k, the width dₛ, and the distance h are uniform.

As shown in Equation 1 and FIG. 4C, the deposition material passing through the patterning slit 151b′ at a critical incident angle θ_{b}′ forms the thin film 160 that is shifted to the left by PS₁′. Similarly, the deposition material passing through the patterning slit 151c′ at a critical incident angle θ_{c}′ forms the thin film 160 that is shifted to the left by PS₂′. Similarly, the deposition material passing through the patterning slit 151d′ at a critical incident angle θ_{d}′ forms the thin film 160 shifted to the left by PS₃′. Finally, the deposition material passing through the patterning slit 151e′ at a critical incident angle θₑ′ forms the thin film 160 shifted to the left by PS₄′.

Herein, the relation of θ_{b}′<θ_{c}′<θ_{d}′<θₑ′ is established, and thus the relation of PS₁′<PS₂′<PS₃′<PS₄′, which defines the relationship between the pattern shifts of the patterning slits 151′, is also satisfied. As such, when the patterning slits 151′ of the patterning slit sheet 150′ are formed at equal intervals, the pattern shifts increase from the center to the edge of the patterning slit sheet 150′, and thus errors in locations of patterns may increase.

Accordingly, in the thin film deposition apparatus 100, neighboring patterning slits 151 are formed nearer to each other the farther they are from the center of the patterning slit sheet 150. FIG. 5A illustrates the neighboring patterning slits 151 formed nearer together the farther they are from the center of the patterning slit sheet 150, in the thin film deposition apparatus 100 of FIG. 1, according to another embodiment of the present invention and FIG. 5B illustrates the thin film 160 formed on the substrate 400 (not shown) by using the patterning slit sheet 150 of FIG. 5A.

FIGS. 5A and 5B illustrate the patterning slit sheet 150 including the patterning slits 151, where the intervals between the neighboring patterning slits 151 narrow the farther they are from the center of the patterning slit sheet 150. That is, in FIG. 5A, the relation of I₁>I₂>I₃>I₄ is established.

In detail, the interval I₂ between patterning slit 151b and patterning slit 151c is smaller than the interval I₁ between patterning slit 151a and patterning slit 151b, the interval I₃ between patterning slit 151c and patterning slit 151d is smaller than the interval I₂ between patterning slit 151b and patterning slit 151c, and the interval I₄ between patterning slit 151d and patterning slit 151e is smaller than the interval I₃ between patterning slit 151c and patterning slit 151d.

As such, intervals between the neighboring patterning slits 151 are narrowed the farther they are from the center of the patterning slit sheet 150 because the pattern shift increases the farther it is from the center as described for equal intervals with reference to FIGS. 4A and 4B. Accordingly, in order to compensate for the pattern shift that increases farther from the center, the intervals between the neighboring patterning slits 150 are narrowed the farther they are from the center.

Here, the interval I₁ between the patterning slit 151a and the patterning slit 151b of FIG. 5A is smaller than the interval I₁′ between the patterning slit 151a′ and the patterning slit 151b′ of FIG. 4A (I₁′>I₁). Also, the interval I₂ between the patterning slit 151b and the patterning slit 151c of FIG. 5A is smaller than the interval I₂′ between the patterning slit 151b′ and the patterning slit 151c′ of FIG. 4A (I₂′>I₂). Also, the interval I₃ between the patterning slit 151c and the patterning slit 151d of FIG. 5A is smaller than the interval I₃′ between the patterning slit 151c′ and the patterning slit 151d′ of FIG. 4A (I₃′>I₃). Also, the interval I₄ between the patterning slit 151d and the patterning slit 151e of FIG. 5A is smaller than the interval I₄′ between the patterning slit 151d′ and the patterning slit 151e′ of FIG. 4A (I₄′>I₄).

As such, compared to the patterning slit sheet 150′ wherein the patterning slits 151′ are disposed at equal intervals, the patterning slits 151 are moved somewhat toward the center of the patterning slit sheet 150 while the intervals between neighboring patterning slits 151 are narrowed the farther they are from the center of the patterning slit sheet 150. Accordingly, overall pattern shifts are decreased. In other words, the first pattern shift PS₁ of FIG. 5A is reduced compared to the first pattern shift PS₁′ of FIG. 4A (PS₁′>PS₁), the second pattern shift PS₂ of FIG. 5A is reduced compared to the second pattern shift PS₂′ of FIG. 4A (PS₂′>PS₂), the third pattern shift PS₃ of FIG. 5A is reduced compared to the third pattern shift PS₃′ of FIG. 4A (PS₃′>PS₃), and the fourth pattern shift PS₄ of FIG. 5A is reduced compared to the fourth pattern shift PS₄′ of FIG. 4A (PS₄′>PSI₄).

As such, by suitably disposing the patterning slits 151a, 151b, 151c, 151d, and 151e, the thin film 160 formed on the substrate 400 may have equal intervals. In other words, the pattern slits 151 of the patterning slit sheet 150 are somewhat compensated, thereby removing a pattern shift phenomenon. Since the pattern shift phenomenon is removed and thus patterns are accurately formed at regular intervals, the performance and reliability of the thin film 160 that is produced may be increased.

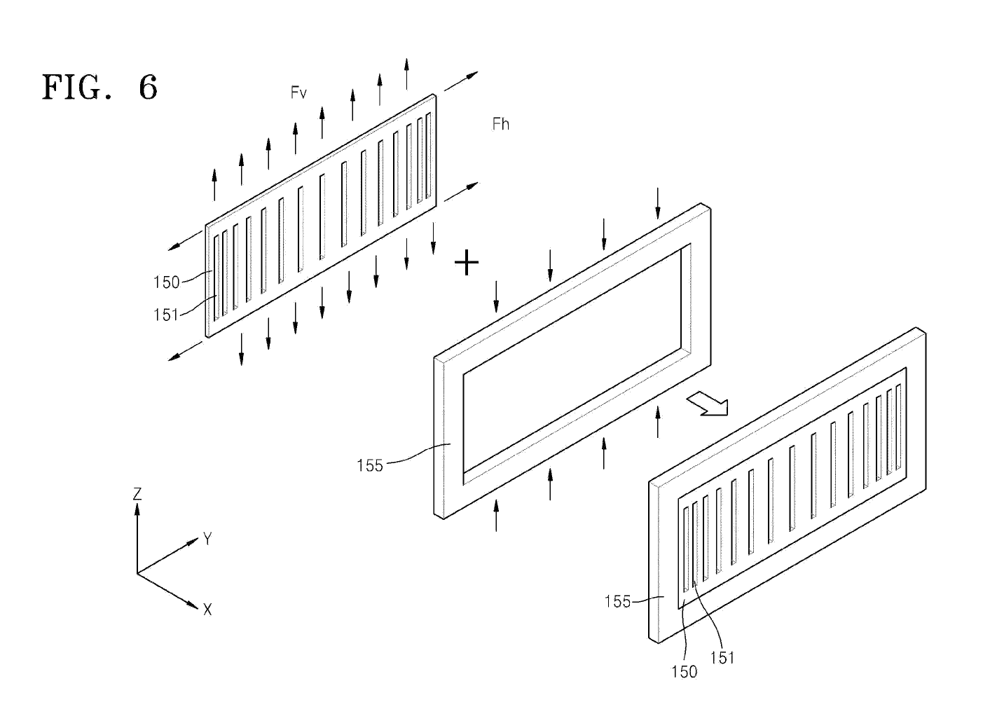

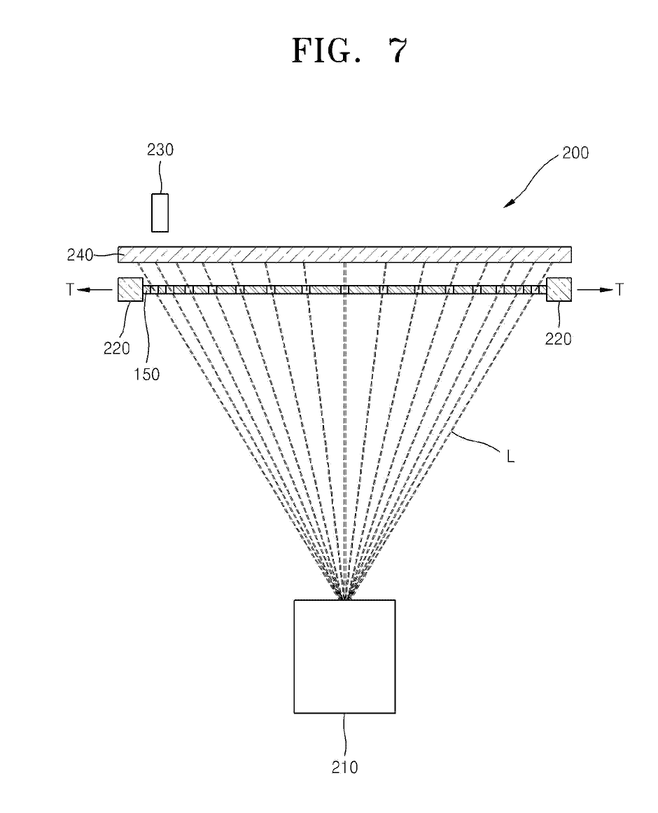

FIG. 6 is a schematic view illustrating the combined structure of the patterning slit sheet 150 and the frame 155, according to another embodiment of the present invention. Referring to FIG. 6, the frame 155 may be formed in a lattice shape, similar to a window frame. The patterning slit sheet 150 including the plurality of patterning slits 151 is bound inside the frame 155. In the thin film deposition apparatus 100, the patterning slit sheet 150 is bound in the frame 155 such that a compression force is exerted on the patterning slit sheet 150 by the frame 155.

In particular, the degree of pattern precision of the patterning slit sheet 150 may be affected by a manufacturing error or by a thermal expansion error of the patterning slit sheet 150. In order to minimize manufacturing errors of the patterning slit sheet 150, a counter force technique used to precisely extend an FMM and weld it to a frame may be used.

This will now be described in detail. Initially, as illustrated in FIG. 6, an external tensile force is applied to the patterning slit sheet 150 so that the patterning slit sheet 150 is stretched outwards. Next, a compression force is applied to the frame 155 in an opposite direction to the direction in which the external tensile force is applied to the patterning slit sheet 150, such that the compression force is in equilibrium with the external tensile force applied to the patterning slit sheet 150. Then, the patterning slit sheet 150 is bound to the frame 155 by, for example, welding edges of the patterning slit sheet 150 to the frame 155. Finally, the patterning slit sheet 150 and the frame 155 are relieved from all the external forces applied thereto to reach equilibrium, so that only a tensile force is exerted on the patterning slit sheet 150 by the frame 155. When such precise extension, compression, and welding techniques as described above are used, the patterning slit sheet 150 may be manufactured with a manufacturing error of 2 μm or less. As such, a predetermined tensile force is exerted on the patterning slit sheet 150 by the frame 155, and thus pattern precision of the patterning slit sheet 150 may be improved.

However, as described with reference to FIGS. 4 and 5, the patterning slits 151 of the patterning slit sheet 150 are not formed at equal intervals, but the intervals of the neighboring patterning slits 151 are narrowed the farther they are from the center of the patterning slit sheet 150. Accordingly, the conventional patterning slit sheet 150 is extended while considering such a pattern shift, but it is not easy to extend a patterning slit sheet considering a pattern shift using a conventional tension apparatus for a patterning slit sheet. In other words, when the conventional tension apparatus is used, a certain area of a patterning slit sheet is extended to be longer than other areas, but such a method is not really feasible.

Accordingly, a tension apparatus for a patterning slit sheet, according to another embodiment of the present invention includes a light source at a location corresponding to a deposition source of a thin film deposition apparatus so that a pattern shape identical to the shape of a thin film deposited by the thin film deposition apparatus is projected onto a master glass. Then, the tension apparatus extends the patterning slit sheet while aligning the patterning slit sheet with the master glass, thereby accurately and easily extending the patterning slit sheet. This will be now described in detail.

FIG. 7 is a schematic view of a tension apparatus 200 for a patterning slit sheet, according to this embodiment of the present invention. Referring to FIG. 7, the tension apparatus 200 includes a light source 210, a tension member 220, an alignment control member 230, and a master glass 240.

The master glass 240 is formed on a location corresponding to the substrate 400 of FIG. 1 on which a deposition material is deposited, and a reference pattern having the same shape as a thin film deposited on the substrate 400 is formed on the master glass 240. The reference pattern functions as a reference point for extending the patterning slit sheet 150. Here, the reference pattern formed on the master glass 240 may be a stripe type pattern of equal intervals.

The light source 210 may be disposed at a location where the deposition source 110 is actually disposed in the thin film deposition apparatus 100 of FIG. 3. The light source 210 emits a predetermined light L, and the emitted light L is irradiated on the master glass 240 through the patterning slit sheet 150.

The tension member 220 is disposed on at least both sides of the patterning slit sheet 150. In detail, the tension member 220 is disposed to surround the patterning slit sheet 150, thereby applying a predetermined tensile force T to the patterning slit sheet 150.

The alignment control member 230 is disposed at a side of the master glass 240 opposite to a side of the master glass that faces the patterning slit sheet 150. Here, the alignment control member 230 includes a photographing apparatus (not shown) and a gap sensor (not shown).

In detail, the photographing apparatus photographs and compares the pattern of the light L that is emitted from the light source 210 and projected onto the master glass 240 through the patterning slit sheet 150 with the reference pattern pre-formed on the master glass 240. In other words, the tension member 220 extends the patterning slit sheet 150 in such a way that the pattern of the light L projected onto the master glass 240 and the reference pattern on the master glass 240, which are photographed by the photographing apparatus of the align control member 230, match each other.

Meanwhile, the gap sensor measures the interval between the patterning slit sheet 150 and the master glass 240. As described above, the patterning slit sheet 150 and the substrate 400 of FIG. 1 are spaced apart from each other by a predetermined distance, and when the predetermined distance varies, the shape of a thin film formed on the substrate 400 also varies. Accordingly, while extending the patterning slit sheet 150, the patterning slit sheet 150 and the master glass 240 must maintain a uniform interval. Thus, the gap sensor continuously measures the interval between the patterning slit sheet 150 and the master glass 240, and the gap control member (not shown) may maintain the interval between the patterning slit sheet 150 and the master glass 240 to be uniform.

As described above, the light source 210 is disposed at a location corresponding to a deposition source of a thin film deposition apparatus so that a pattern shape identical to a shape of a thin film deposited by the thin film deposition apparatus is projected onto the master glass 240. Then, the patterning slit sheet 150 is extended while the patterning slit sheet 150 is aligned with the master glass 240, thereby accurately and easily extending the patterning slit sheet 150.

Aspects of the present invention provide a tension apparatus for a patterning slit sheet included in a thin film deposition apparatus that may be easily manufactured, that may be simply applied to produce large-sized display devices on a mass scale, and that improves manufacturing yield and deposition efficiency.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A tension apparatus for extending a patterning slit sheet, wherein a plurality of patterning slits are formed along a first direction in the patterning slit sheet, and distances between adjacent patterning slits are different from each other, the tension apparatus comprising:
a light source disposed to face the patterning slit sheet and irradiating light toward the patterning slit sheet;
a tension member combined to at least one end of the patterning slit sheet, and applying a predetermined tensile force on the patterning slit sheet; and
a master glass onto which light irradiated from the light source and passed through the patterning slit sheet is projected.

2. The tension apparatus of claim 1, wherein a predetermined reference pattern is formed on the master glass.

3. The tension apparatus of claim 2, wherein the reference pattern is a stripe type pattern of equal intervals.

4. The tension apparatus of claim 2, wherein the reference pattern has the same shape as a thin film pattern deposited on a substrate by the patterning slit sheet.

5. The tension apparatus of claim 2, further comprising a photographing apparatus for photographing a pattern of the light projected onto the master glass after being irradiated from the light source and passed through the patterning slit sheet, and the reference pattern formed on the master glass.

6. The tension apparatus of claim 5, wherein the tension member extends the patterning slit sheet in such a way that the pattern of the light and the reference pattern photographed by the photographing apparatus are identical.

7. The tension apparatus of claim 1, further comprising a gap sensor for measuring an interval between the patterning slit sheet and the master glass, and a gap control member for uniformly maintaining the measured interval between the patterning slit sheet and the master glass.

8. The tension apparatus of claim 1, wherein the light source is formed at a location corresponding to a deposition source of a thin film deposition apparatus including the patterning slit sheet.

9. The tension apparatus of claim 1, wherein the distances between the patterning slits decrease the farther they are from the center of the patterning slit sheet along the first direction.

10. The tension apparatus of claim 1, wherein the patterning slits are biased toward the center of the patterning slit sheet compared to when the patterning slits are disposed on the patterning slit sheet at equal intervals.

11. The tension apparatus of claim 10, wherein the patterning slits are more biased toward the center of the patterning slit sheet the farther they are from the center of the patterning slit sheet.

12. A patterning slit sheet manufactured by using the tension apparatus of claim 1.

13. A thin film deposition apparatus comprising a deposition source, a deposition source nozzle unit and a patterning slit sheet, the patterning slit sheet comprising a plurality of parallel patterning slits arranged in one direction within the patterning slit sheet, wherein one of the thin film deposition apparatus and a substrate can be moved relative to the other.

14. The thin film deposition apparatus of claim 13, wherein the intervals between adjacent patterning slits are equal.

15. The thin film deposition apparatus of claim 13, wherein the intervals between adjacent patterning slits decrease from the center of the patterning slit sheet to the outer edges of the patterning slit sheet.

16. The thin film deposition apparatus of claim 13, further comprising a tension apparatus for extending the patterning slit sheet, wherein the tension apparatus comprises:
a light source disposed to face the patterning slit sheet and irradiating light toward the patterning slit sheet,
a tension member combined to at least one end of the patterning slit sheet, and applying a predetermined tensile force on the patterning slit sheet, and
a master glass onto which light irradiated from the light source and passed through the patterning slit sheet is projected.
